(19) United States
(12) Patent Application Publication
(10) Pub. No.: US 2024/0289098 A1
(43) Pub. Date: Aug. 29, 2024

(54) Functional Safety Software Image Integrity Verifier

(71) Applicant: QUALCOMM Incorporated, San Diego, CA (US)

(72) Inventors: Xiang LI, Shanghai (CN); Serafim LOUKAS, Jr., Carlsbad, CA (US); Gurunath RAMASWAMY, San Diego, CA (US); Hua ZHANG, Shanghai (CN); Yong DING, Shanghai (CN)

(21) Appl. No.: 18/573,069

(22) PCT Filed: Aug. 30, 2021
(86) PCT No.: PCT/CN2021/115241

§ 371 Date: Dec. 21, 2023

(51) Int. Cl. G06F 8/30

(52) U.S. Cl. CPC G06F 8/30

(57) ABSTRACT

Various embodiments include methods and devices for generating and verifying a software image with a safety feature. Embodiments may include generating a safety feature from a first software image, and generating a second software image including the safety feature. Embodiments may include, retrieving a first safety feature from a software image with the first safety feature, calculating a second safety feature based on information relating to the software image with the first safety feature, comparing the first safety feature and the second safety feature, and verifying safety of the software image with the first safety feature in response to the first safety feature matching with the second safety feature. The methods and devices may be implemented in compliance with functional safety standards, such as ISO 26262 functional safety standards and, in compliance with Automotive Safety Integrity Level (ASIL) requirements, such as ASIL-D and/or ASIL QM requirements.

### RELATED APPLICATIONS

This application is the U.S. national stage application for and claims priority to PCT Application No. PCT/CN2021/115241 entitled “Functional Safety Software Image Integrity Verifier” that was filed Aug. 30, 2021, the entire contents of which are incorporated herein by reference for all purposes.

### BACKGROUND

With modern automobiles being run and regulated by automotive electronic control units (ECUs), implementation of advanced safety features across an increasing swath of automobiles has become inevitable. In all automotive software components, a boot sequence and its bootloader are always the first process for loading and implementing the software components. The boot sequence and its bootloader have an important role in the overall function of the advanced safety features.

### SUMMARY

Various disclosed aspects include apparatuses and methods of generating a software image. Various aspects may include generating a safety feature from a first software image, and generating a second software image including the safety feature. In some aspects, generating the second software image including the safety feature may include embedding the safety feature in the first software image.

In some aspects, generating the safety feature from the first software image may include retrieving information relating to segments of the first software image and calculating an error detection code based on the information relating to the segments of the first software image producing a checksum value, and generating the second software image including the safety feature may include generating the second software image including the checksum value.

In some aspects, generating the second software image including the safety feature may include generating a software image verifier (SWIV) header, generating a SWIV segment including the safety feature, and generating the second software image including the SWIV header and the SWIV segment.

In some aspects, generating the safety feature from the first software image may include generating the safety feature via a functional safety standard compliant module, and generating the second software image including the safety feature may include generating the second software image including the safety feature via the functional safety standard compliant module. In some aspects, the functional safety standard compliant module may be an ISO 26262 functional safety standard compliant module. In some aspects, the functional safety standard compliant module may be an Automotive Safety Integrity Level (ASIL)-QM functional safety standard compliant module.

Further disclosed aspects may include apparatuses and methods of verifying a software image. Various aspects may include retrieving a first safety feature from a software image with the first safety feature, calculating a second safety feature based on information relating to the software image with the first safety feature, comparing the first safety feature and the second safety feature, and verifying safety of the software image with the first safety feature in response to the first safety feature matching the second safety feature. In some aspects, retrieving the first safety feature from the software image with the first safety feature may include retrieving the first safety feature from a software image verifier (SWIV) segment of the software image with the first safety feature.

Some aspects may further include retrieving the information relating to the software image with the first safety feature from the software image with the first safety feature, generating a software image verifier (SWIV) context including the first safety feature and the information relating to the software image with the first safety feature, retrieving the information relating to the software image with the first safety feature from the SWIV context, in which calculating the second safety feature based on the information relating to the software image with the first safety feature may include calculating the second safety feature based on the information relating to the software image retrieved from the SWIV context, and retrieving the first safety feature from the SWIV context, in which comparing the first safety feature and the second safety feature may include comparing the first safety feature retrieved from the SWIV context and the second safety feature.

Some aspects may further include loading the software image with the first safety feature to a volatile memory, in which retrieving the first safety feature from the software image with the first safety feature, calculating the second safety feature based on the information relating to the software image with the first safety feature, comparing the first safety feature and the second safety feature, and verifying the safety of the software image with the first safety feature in response to the first safety feature matching with the second safety feature may occur following loading the software image with the first safety feature to the volatile memory.

In some aspects, retrieving the first safety feature from the software image with the first safety feature, calculating the second safety feature based on the information relating to the software image with the first safety feature, comparing the first safety feature and the second safety feature, and verifying the safety of the software image with the first safety feature in response to the first safety feature matching with the second safety feature may occur prior to each execution of the software image with the first safety feature.

In some aspects, retrieving the first safety feature from the software image with the first safety feature may include retrieving the first safety feature from the software image with the first safety feature via a functional safety standard compliant module, calculating the second safety feature based on information relating to the software image with the first safety feature may include calculating the second safety feature based on the information relating to the software image with the first safety feature via the functional safety standard compliant module, comparing the first safety feature and the second safety feature may include comparing the first safety feature and the second safety feature via the functional safety standard compliant module, and verifying safety of the software image with the first safety feature in response to the first safety feature matching with the second safety feature may include verifying the safety of the software image with the first safety feature via the functional safety standard compliant module. In some aspects, the functional safety standard compliant module may be an ISO 26262 functional safety standard compliant module. In some aspects, the functional safety standard compliant module may be an Automotive Safety Integrity Level (ASIL)-D functional safety standard compliant module.

Further aspects include a computing device having a processing device configured to perform operations of any of the methods summarized above. Further aspects include a computing device having means for performing functions of any of the methods summarized above. Further aspects include a non-transitory processor-readable medium having stored thereon processor-executable instructions configured to cause a processor and other components of a computing device to perform operations of any of the methods summarized above.

### BRIEF DESCRIPTION OF THE DRAWINGS

The accompanying drawings, which are incorporated herein and constitute part of this specification, illustrate example embodiments of various embodiments, and together with the general description given above and the detailed description given below, serve to explain the features of the claims.

FIG. 1 is a component block diagram illustrating an example computing device suitable for implementing various embodiments.

FIG. 2 is a block diagram illustrating a functional safety standard compliant software image verifier suitable for implementing various embodiments.

FIG. 3 is a block and flow diagram illustrating an example of generating a software image with a safety feature using functional safety standard compliant modules in accordance with various embodiments.

FIG. 4 is a block and flow diagram illustrating an example of verifying a software image with a safety feature using functional safety standard compliant modules in accordance with various embodiments.

FIG. 5 is a block and flow diagram illustrating an example of loading and verifying a software image with a safety feature using functional safety standard compliant modules in accordance with various embodiments.

FIG. 6 is a process flow diagram illustrating a method for generating a software image with a safety feature using functional safety standard compliant modules according to an embodiment.

FIG. 7 is a process flow diagram illustrating a method for generating a software image with a safety feature using functional safety standard compliant modules according to an embodiment.

FIG. 8 is a process flow diagram illustrating a method for verifying a software image with a safety feature using functional safety standard compliant modules according to an embodiment.

FIG. 9 is a process flow diagram illustrating a method for verifying a software image with a safety feature using functional safety standard compliant modules according to an embodiment.

FIG. 10 is a component block diagram illustrating an example mobile computing device suitable for implementing various embodiments.

FIG. 11 is a component block diagram illustrating an example mobile computing device suitable for implementing various embodiments.

FIG. 12 is a component block diagram illustrating an example server suitable for implementing various embodiments.

FIGS. 13A-13C are component block diagrams illustrating an example embedded vehicle computing system suitable for implementing various embodiments.

### DETAILED DESCRIPTION

Various embodiments will be described in detail with reference to the accompanying drawings. Wherever possible, the same reference numbers will be used throughout the drawings to refer to the same or like parts. References made to particular examples and implementations are for illustrative purposes, and are not intended to limit the scope of the claims.

Various embodiments include methods, and computing devices implementing such methods of generating and verifying a software image with functional safety standard compliant software image items. Generating a software image with functional safety standard compliant software image items may be achieved by functional safety standard compliant modules. Verifying the software image with functional safety standard compliant software image items may be achieved by functional safety standard compliant modules. The functional safety standard compliant modules may comply with functional safety standards, such as International Organization for Standardization (ISO) 26262 functional safety standards. For example, functional safety standard compliant modules may comply with Automotive Safety Integrity Level (ASIL) requirements, such as ASIL-D and/or ASIL QM requirements. Various embodiments may be implemented in a safety critical system, such as vehicular systems including automotive, avionic, marine, and space systems.

The term “computing device” may refer to stationary computing devices including personal computers, desktop computers, all-in-one computers, workstations, super computers, mainframe computers, embedded computers (such as in vehicles and other larger systems), computerized vehicles (e.g., partially or fully autonomous terrestrial, aerial, and/or aquatic vehicles, such as passenger vehicles, commercial vehicles, recreational vehicles, military vehicles, drones, etc.), servers, multimedia computers, and game consoles. The terms “computing device” and “mobile computing device” are used interchangeably herein to refer to any one or all of cellular telephones, smartphones, personal or mobile multi-media players, personal data assistants (PDA's), laptop computers, tablet computers, convertible laptops/tablets (2-in-1 computers), smartbooks, ultrabooks, netbooks, palm-top computers, wireless electronic mail receivers, multimedia Internet enabled cellular telephones, mobile gaming consoles, wireless gaming controllers, and similar personal electronic devices that include a memory, and a programmable processor.

Various embodiments are described in terms of code, e.g., processor-executable instructions, for ease and clarity of explanation, but may be similarly applicable to any data, e.g., code, program data, or other information stored in memory. The terms “code”, “data”, and “information” are used interchangeably herein and are not intended to limit the scope of the claims and descriptions to the types of code, data, or information used as examples in describing various embodiments.

Modern critical systems, such as safety-critical software executing in vehicle ECUs, rely on correct and reliable executable code and data to safely execute their safety-critical operations. In such critical systems implement software components, a boot sequence and its boot loader are the first to execute. The boot sequence and its bootloader (or image loader) play an important role in the overall function in the correct and reliable implementation of the critical systems. Current boot loaders are not complaint with functional safety standards. Further, current boot sequences implement boot loaders that can verify software image security features when a secure boot is implemented. Thus, software images loaded by the boot loader when a secure boot is not implemented are not verified by the image loader. This can present a weakness in conventional vehicle software systems.

Boot loaders also lack an ability to verify safety of software images. Not verifying safety of software images can fail to mitigate hazards caused by an intact software image loaded into a wrong destination address, data being corrupted by systematic or random faults of the boot loader itself, and/or failure to load the software image. When boot loaders fail to properly load software images, a corrupted software image will be loaded into random access memory (RAM). When this happens, expected data for executing a system critical function may be incorrect or even a whole image for executing the system critical function may not be executable.

Various embodiments include methods, and devices for implementing such methods, for generating and verifying images of critical system software for critical systems by a functional safety standard compliant modules that is configured to improve functional safety of the boot sequence and its boot loader. Such modules may include modules and submodules that comply with functional safety standards, such as ISO 26262 functional safety standards. For example, functional safety standard compliant modules may comply with ASIL requirements, such as ASIL-D and/or ASIL QM requirements. The functional safety standard compliant modules may be developed, tested, and/or implemented in compliance with the functional safety standards.

A functional safety standards compliant module may include a functional safety standards compliant software image verifier (SWIV) module configured to generate software images with a safety feature and verify the software images based on the safety feature. For example, the safety feature may include a checksum calculated for all loadable segments of a software image. Generating software images with the safety feature may include calculating the safety feature and including the safety feature in the software images. Verifying the software images with the safety feature may include retrieving the safety feature from the software images, calculating the safety feature for the software image, and comparing the retrieved safety feature and the calculated safety feature to determine whether to verify the safety of the software image. Verification of the safety of the software images with safety features may verify that the software images with the safety features are correctly loaded to RAM. For example, the software images with the safety features are correctly loaded to RAM when the expected parts of the software images with the safety features are loaded to the RAM at expected destination address with noncorrupted or intact data.

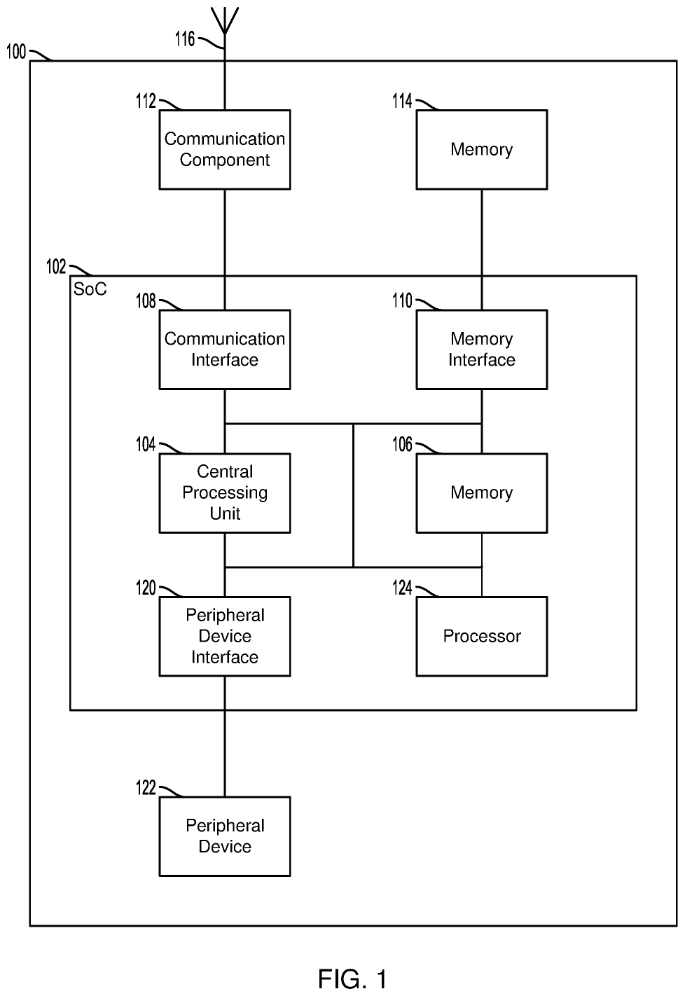

FIG. 1 illustrates a system including a computing device 100 suitable for use with various embodiments. The computing device 100 may include an SoC 102 with a central processing unit 104, a memory 106, a communication interface 108, a memory interface 110, a peripheral device interface 120, and a processing device 124. The computing device 100 may further include a communication component 112, such as a wired or wireless modem, a memory 114, an antenna 116 for establishing a wireless communication link, and/or a peripheral device 122. The processor 124 may include any of a variety of processing devices, for example a number of processor cores.

The term “system-on-chip” or “SoC” is used herein to refer to a set of interconnected electronic circuits typically, but not exclusively, including a processing device, a memory, and a communication interface. A processing device may include a variety of different types of processors 124 and/or processor cores, such as a general purpose processor, a central processing unit (CPU) 104, a digital signal processor (DSP), a graphics processing unit (GPU), an accelerated processing unit (APU), a secure processing unit (SPU), an intellectual property unit (IPU), a subsystem processor of specific components of the computing device, such as an image processor for a camera subsystem or a display processor for a display, an auxiliary processor, a peripheral device processor, a single-core processor, a multicore processor, a controller, and/or a microcontroller. A processing device may further embody other hardware and hardware combinations, such as a field programmable gate array (FPGA), an application-specific integrated circuit (ASIC), other programmable logic device, discrete gate logic, transistor logic, performance monitoring hardware, watchdog hardware, and/or time references. Integrated circuits may be configured such that the components of the integrated circuit reside on a single piece of semiconductor material, such as silicon.

An SoC 102 may include one or more CPUs 104 and processors 124. The computing device 100 may include more than one SoC 102, thereby increasing the number of CPUs 104, processors 124, and processor cores. The computing device 100 may also include CPUs 104 and processors 124 that are not associated with an SoC 102. Individual CPUs 104 and processors 124 may be multicore processors. The CPUs 104 and processors 124 may each be configured for specific purposes that may be the same as or different from other CPUs 104 and processors 124 of the computing device 100. One or more of the CPUs 104, processors 124, and processor cores of the same or different configurations may be grouped together. A group of CPUs 104, processors 124, or processor cores may be referred to as a multi-processor cluster.

The memory 106 of the SoC 102 may be a volatile or non-volatile memory configured for storing data and processor-executable code for access by the CPU 104, the processor 124, or other components of SoC 102. The computing device 100 and/or SoC 102 may include one or more memories 106 configured for various purposes. One or more memories 106 may include volatile memories such as random-access memory (RAM) or main memory, or cache memory. These memories 106 may be configured to temporarily hold a limited amount of data received from a data sensor or subsystem, data and/or processor-executable code instructions that are requested from non-volatile memory, loaded to the memories 106 from non-volatile memory in anticipation of future access based on a variety of factors, and/or intermediary processing data and/or processor-executable code instructions produced by the CPU 104 and/or processor 124 and temporarily stored for future quick access without being stored in non-volatile memory. In some embodiments, any number and combination of memories 106 may include one-time programmable or read-only memory.

The memory 106 may be configured to store data and processor-executable code, at least temporarily, that is loaded to the memory 106 from another memory device, such as another memory 106 or memory 114, for access by one or more of the CPU 104, the processor 124, or other components of SoC 102. The data or processor-executable code loaded to the memory 106 may be loaded in response to execution of a function by the CPU 104, the processor 124, or other components of SoC 102. Loading the data or processor-executable code to the memory 106 in response to execution of a function may result from a memory access request to the memory 106 that is unsuccessful, or a “miss,” because the requested data or processor-executable code is not located in the memory 106. In response to a miss, a memory access request to another memory 106 or memory 114 may be made to load the requested data or processor-executable code from the other memory 106 or memory 114 to the memory 106. Loading the data or processor-executable code to the memory 106 in response to execution of a function may result from a memory access request to another memory 106 or memory 114, and the data or processor-executable code may be loaded to the memory 106 for later access.

The memory interface 110 and the memory 114 may work in unison to allow the computing device 100 to store data and processor-executable code on a volatile and/or non-volatile storage medium, and retrieve data and processor-executable code from the volatile and/or non-volatile storage medium. The memory 114 may be configured much like an embodiment of the memory 106 in which the memory 114 may store the data or processor-executable code for access by one or more of the CPU 104, the processor 124, or other components of SoC 102. In some embodiments, the memory 114, being non-volatile, may retain the information after the power of the computing device 100 has been shut off. When the power is turned back on and the computing device 100 reboots, the information stored on the memory 114 may be available to the computing device 100. In some embodiments, the memory 114, being volatile, may not retain the information after the power of the computing device 100 has been shut off. The memory interface 110 may control access to the memory 114 and allow the CPU 104, the processor 124, or other components of the SoC 12 to read data from and write data to the memory 114.

Some or all of the components of the computing device 100 and/or the SoC 102 may be arranged differently and/or combined while still serving the functions of the various embodiments. The computing device 100 may not be limited to one of each of the components, and multiple instances of each component may be included in various configurations of the computing device 100.

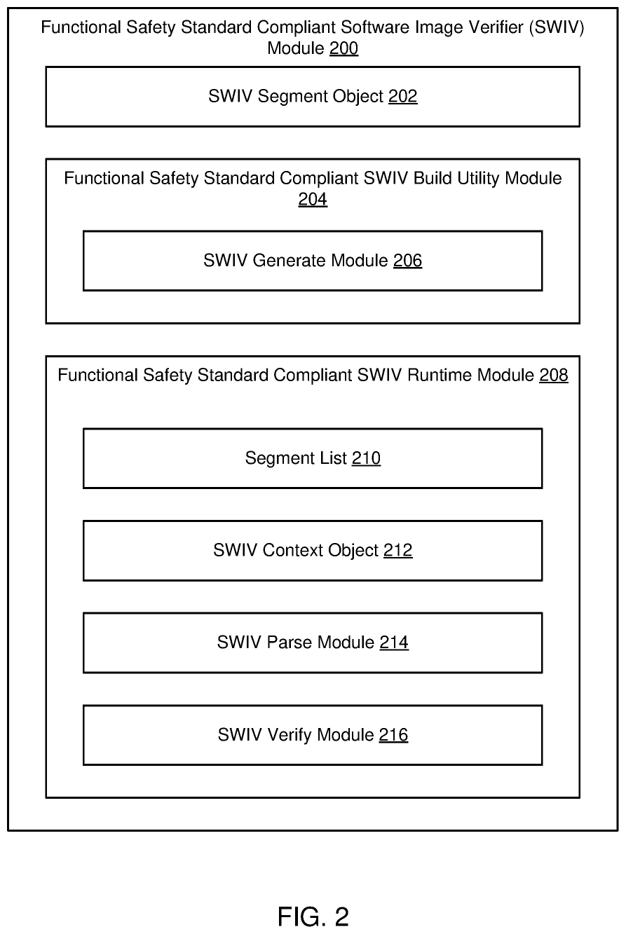

FIG. 2 illustrates a functional safety standard compliant software image verifier (SWIV) suitable for implementing various embodiments. With reference to FIGS. 1 and 2, a functional safety standard compliant SWIV module 200 (or SWIV module 200) may include submodules, a functional safety standard compliant SWIV build utility module 204 (or SWIV build utility module 204) and a functional safety standard compliant SWIV runtime module 208 (or SWIV runtime module 208). Each of the functional safety standard compliant modules 200, 204, 208 may comply with functional safety standards, such as ISO 26262 functional safety standards. For example, functional safety standard compliant modules 200, 204, 208 may comply with ASIL requirements, such as ASIL-D and/or ASIL QM requirements. The functional safety standard compliant modules 200, 204, 208 may be developed, tested, and/or implemented in compliance with the functional safety standards. The functional safety standard compliant modules 200, 204, 208 may be implemented in software executing in a processor (e.g., CPU 104, processor 124 in FIG. 1), dedicated hardware, and/or in a combination of software executing in the processor and dedicated hardware.

The functional safety standard compliant SWIV module 200 may instantiate a SWIV segment object 202, which may be used by the functional safety standard compliant SWIV build utility module 204 and the functional safety standard compliant SWIV runtime module 208, as described further herein. The SWIV segment object 202 may contain information relevant to verifying the safety of a software image with a safety feature. For example, the SWIV segment object 202 may contain a checksum calculated from all loadable segments of a software image for which the software image with the safety feature is generated. Verification of the safety of the software image with the safety feature may verify that the software image with the safety feature is correctly loaded to RAM (e.g., memory 106 in FIG. 1). For example, the software image with the safety feature is correctly loaded to RAM when the expected parts of the software image with the safety feature are loaded to the RAM at expected destination address with noncorrupted or intact data.

The SWIV segment object 202 may also contain information relevant to verifying the security of the software image with the safety feature. For example, the SWIV segment object 202 may contain a security feature, such as magic number for use with cryptographic functions for securing the software image with the safety feature. The security feature may be used to apply cryptographic functions for securing the software image with the safety feature and to unsecure the software image with the safety feature. Securing the software image with the safety feature enables use of existing means for securing a software image, without alteration, to secure the software image with the safety feature. For example hashing and unhashing of a software image may be similarly applied hash the software image with the safety feature.

The functional safety standard compliant SWIV build utility module 204 may be implemented for a software image builder executed on a computing device (e.g., computing device 100 in FIG. 1). The SWIV build utility module 204 may include a SWIV generate module 206 configured to generate a software image with a safety feature. The image builder may build a software image, and the SWIV generate module 206 may analyze the software image, generate the safety feature, and generate the software image with the safety feature. The generated software image with the safety feature may be the software image with an added SWIV segment object 202 having the safety feature generated by the SWIV generate module 206. The SWIV build utility module 204 and the SWIV generate module 206 may comply with functional safety standards, such as ISO 26262 functional safety standards. For example, the SWIV build utility module 204 and the SWIV generate module 206 may comply with ASIL-D and/or ASIL-QM requirements.

The functional safety standard compliant SWIV runtime module 208 may be implemented at runtime of a critical system of a computing device (e.g., computing device 100 in FIG. 1). For example, the SWIV runtime module 208 may be implemented for a software image with a safety feature following being loaded to a RAM (e.g., memory 106 in FIG. 1) by an image loader, such as during a boot sequence of the critical system. As another example, the SWIV runtime module 208 may be implemented for the software image with the safety feature that is loaded to the RAM prior to execution of the software image, such as each time the software image is to be executed as part of the critical system. The SWIV runtime module 208 may instantiate a segment list 210, which may be configured to contain a segment identifier and a memory location identifier, such as an address, address range, address offset, pointer, etc., for each loadable segment of the software image with the safety feature. The SWIV runtime module 208 may instantiate a SWIV context object 212, which may be configured to contain the safety feature, an indicator of a number of loadable segments from the software image with the safety feature, and the segment list 210. The SWIV runtime module 208 may comply with functional safety standards, such as ISO 26262 functional safety standards. For example, the SWIV runtime module 208 may comply with ASIL-D and/or ASIL-QM requirements.

The functional safety standard compliant SWIV runtime module 208 may contain submodules. A submodule of the SWIV runtime module 208 may include a SWIV parse module 214 that may be configured to retrieve information from the software image with the safety feature and generating a segment list 210 and a SWIV context object 212. A submodule of the SWIV runtime module 208 may include a SWIV verify module 216 that may be configured to retrieve a safety feature from the SWIV context object 212, to calculate a safety feature from the data of the SWIV context object 212 and compare the retrieved safety feature and the calculated safety feature to determine whether to verify the safety of the software image with the safety feature. The SWIV parse module 214 and the SWIV verify module 216 may comply with functional safety standards, such as ISO 26262 functional safety standards. For example, the SWIV parse module 214 and the SWIV verify module 216 may comply with ASIL-D and/or ASIL-QM requirements.

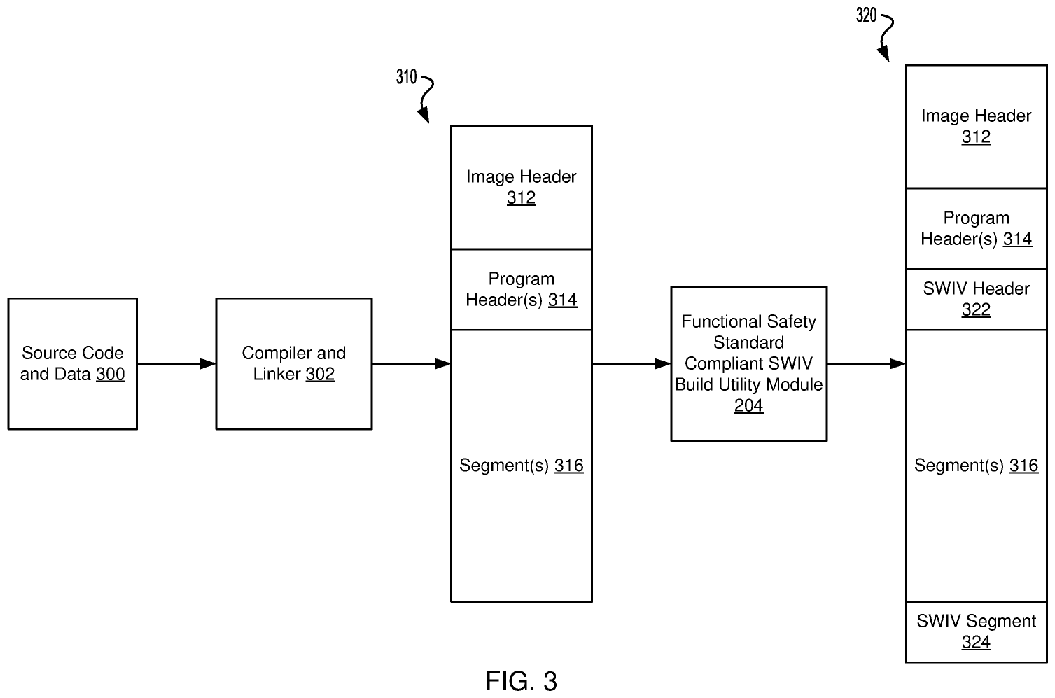

FIG. 3 illustrates an example of generating a software image with a safety feature using functional safety standard compliant modules for implementing various embodiments. With reference to FIGS. 1-3, an image builder implemented on a computing device (e.g., computing device 100 in FIG. 1) may generate a software image with a safety feature 320 from a software image 310 generated from a source code and data 300. The image builder may receive the source code and data 300 and implement a complier and linker 302 to generate the software image 310 of the source code and data 300. The software image 310 may be of any format software image, such as an executable and linkable format (ELF) software image, a multi boot image (MBN) format software image, etc. The software image 310 may contain an image header 312 containing metadata for the software image 310, any number of program headers 314 containing metadata for the loadable segments 316 of the software image 310, and any number of segments 316 containing the complied binary of the source code and data 300.

The image builder may implement the functional safety standard compliant SWIV build utility module 204 for the software image 310. The SWIV build utility module 204 may retrieve/receive software image information from the software image 310. Such software image information may include information relating to the loadable segments 316 of the software image 310. For example, software image information may include a number of the loadable segments 316, a size of the loadable segments 316, etc. Using the software image information, the SWIV build utility module 204 may generate the safety feature for use in generating the software image with the safety feature 320. For example, the SWIV build utility module 204 may calculate an error detection code checksum based on all loadable segments the software image information as the safety feature. For example, the SWIV build utility module 204 may calculate a cyclic redundancy check (CRC) checksum as the safety feature.

The SWIV build utility module 204 may generate a SWIV header 322 and a SWIV segment 324 for the software image with the safety feature 320. The SWIV header 322 may contain metadata for the SWIV segment 324, such as an memory location identifier, such as an address, address range, address offset, pointer, etc., for the SWIV segment 324 when loaded to RAM (e.g., memory 106 in FIG. 1). The SWIV segment 324 may include the safety feature. The SWIV segment 324 may also include a magic number for use with cryptographic functions for securing the software image with the safety feature 320. The SWIV build utility module 204 may generate the software image with the safety feature 320. For example, the SWIV build utility module 204 may add the SWIV header 322 and the SWIV segment 324 to the software image 310, generating the software image with the safety feature 320. The SWIV header 322 may be added to the software image 310 adjacent to, such as following, the program headers 314. The SWIV segment 324 may be added to the software image 310 adjacent to the segments 316, such as following the segments 316.

The SWIV build utility module 204 may be implemented in software executing in a processor (e.g., CPU 104, processor 124 in FIG. 1), dedicated hardware, and/or in a combination of software executing in the processor and dedicated hardware.

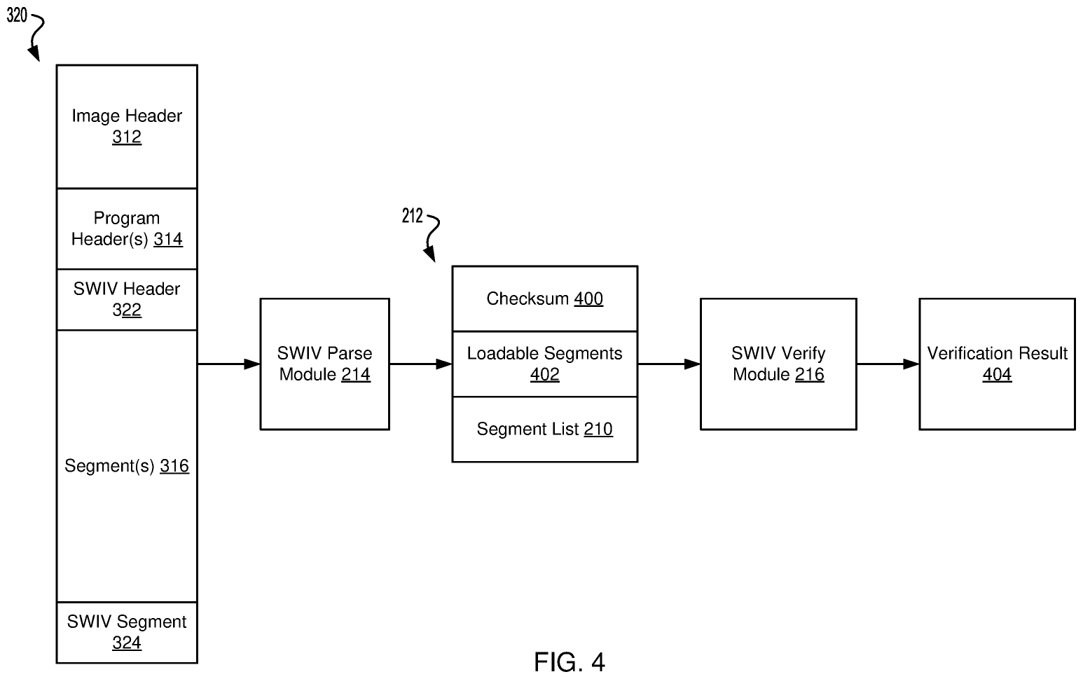

FIG. 4 illustrates an example of verifying a software image with a safety feature using functional safety standard compliant modules for implementing various embodiments. With reference to FIGS. 1-4, an image loader implemented on a computing device (e.g., computing device 100 in FIG. 1) may load the software image with the safety feature 320 that may be verified by the functional safety standard compliant SWIV runtime module 208 implemented on the computing device. The computing device implementing the SWIV runtime module 208 may be different from a computing device (e.g., computing device 100 in FIG. 1) implementing the functional safety standard compliant SWIV build utility module (e.g., the functional safety standard compliant SWIV build utility module 204 in FIGS. 2 and 3).

The SWIV runtime module 208 may retrieve/receive information from the software image with the safety feature 320. For example, the SWIV runtime module 208 may retrieve/receive information from the software image with the safety feature 320 by executing the SWIV parse module 214 The information may include the safety feature in the SWIV segment 324 of the software image with the safety feature 320. For example, the SWIV runtime module 208 may retrieve the checksum from the software image with the safety feature 320. The SWIV runtime module 208 may use the information retrieved from the software image with the safety feature 320 to generate a SWIV context object 212. For example, the SWIV context object 212 may be generated having the safety feature, checksum 400, retrieved from the software image with the safety feature 320.

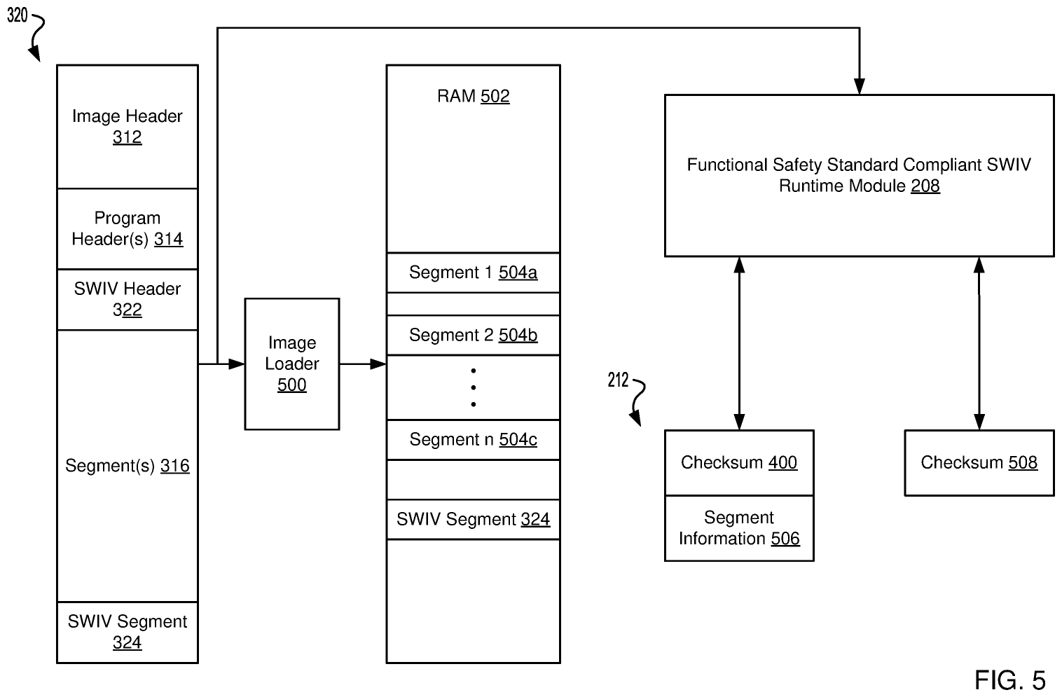

The SWIV runtime module 208 may also analyze information retrieved from the software image with the safety feature 320 and generate information relating to the loadable segments 316. The information may include the data of the program headers 314 and/or the loadable segments 316. For example, the SWIV runtime module 208 may generate information that includes a number of the loadable segments 316, a size of the loadable segments 316, etc. As another example, the SWIV runtime module 208 may generate information that may include a segment identifier and a memory location identifier, such as an address, address range, address offset, pointer, etc., for each loadable segment 316 of the software image with the safety feature 320. The SWIV runtime module 208 may use the information generated from analyzing the software image with the safety feature 320 to generate the SWIV context object 212. For example, the SWIV context object 212 may be generated having a number of the loadable segments 316, shown in FIG. 4 as loadable segments 402. As another example, the SWIV context object 212 may be generated having the segment identifier and the memory location identifier for the loadable segments 316, shown in FIG. 5 as segment list 210.

The SWIV runtime module 208 may verify the safety of the software image with the safety feature 320 based on information of the SWIV context object 212. For example, the SWIV runtime module 208 may verify the safety of the software image with the safety feature 320 by executing the SWIV verify module 216. The SWIV runtime module 208 may use the generated information relating to the loadable segments 316, the loadable segments 402 and/or the segment list 210, to calculate a safety feature of the software image with the safety feature 320. For example, the SWIV runtime module 208 may use the same manner of calculating the safety feature as used by the SWIV build utility module 204 to generate the safety feature. The SWIV runtime module 208 may compare the calculated safety feature with the retrieved safety feature, checksum 400, in the SWIV context object 212 to determine whether to verify the safety of the software image with the safety feature 320. In response to the calculated safety feature and the retrieved safety, checksum 400, feature matching, the SWIV runtime module 208 may verify the safety of the software image with the safety feature 320. In response to the calculated safety feature and the retrieved safety feature, checksum 400, not matching, the SWIV runtime module 208 may not verify the safety of the software image with the safety feature 320. The SWIV runtime module 208 may generate and output a verification result 404, which may be a signal configured to indicate to a processor (e.g., processor 104, 124 in FIG. 1) whether the safety of the software image with the safety feature 320 is verified. Verification of the safety of the software image with the safety feature 320 may verify that the software image with the safety feature 320 is correctly loaded to the RAM. For example, the software image with the safety feature 320 is correctly loaded to the RAM when the expected parts of the software image with the safety feature are loaded to the RAM at expected destination address with noncorrupted or intact data.

The SWIV runtime module 208, the SWIV parse module 214, and the SWIV verify module 216 may be implemented in software executing in a processor (e.g., CPU 104, processor 124 in FIG. 1), dedicated hardware, and/or in a combination of software executing in the processor and dedicated hardware.

FIG. 5 illustrates an example of loading and verifying a software image with a safety feature using functional safety standard compliant modules for implementing various embodiments. With reference to FIGS. 1-5, an image loader 500 implemented on a computing device (e.g., computing device 100 in FIG. 1) may load the software image with the safety feature 320 that may be verified by the functional safety standard compliant SWIV runtime module 208 implemented on the computing device. The image loader 500 may load the software image having the safety feature 320 to a RAM 502 (e.g., memory 106 in FIG. 1) of the computing device. The image loader may load the loadable segments 316 of the software image having the safety feature 320 as segments 504a-504c to the RAM 502 based on metadata from the image header 312 and/or the program headers 314 of the software image having the safety feature 320. For example, the metadata may indicate to the image loader 500 at which locations in the RAM 502 to load the segments 504a-504c. The image loader may load the SWIV segment 324 of the software image having the safety feature 320 to the RAM 502 based on metadata from the SWIV header 322 of the software image having the safety feature 320. For example, the metadata may indicate to the image loader 500 at which location in the RAM 502 to load the SWIV segment 324.

Following the image loader 500 loading the software image having the safety feature 320 to the RAM 502, the SWIV runtime module 208 may verify the safety of the software image having the safety feature 320. For example, the SWIV runtime module 208 may verify the safety of the software image having the safety feature 320 approximately upon completion of the image loader 500 loading the software image having the safety feature 320 to the RAM 502. As another example, the SWIV runtime module 208 may verify the safety of the software image having the safety feature 320 prior to any execution of the software image having the safety feature 320 in the RAM 502, such as any of the segments 504a-504c in the RAM 502.

To verify the safety of the software image having the safety feature 320, the SWIV runtime module 208 may retrieve/receive information from the software image with the safety feature 320 and generate SWIV context object 212. For example, the SWIV runtime module 208 may parse the software image with the safety feature 320 and retrieve the safety feature from the SWIV segment 324. As another example, SWIV runtime module 208 may parse the software image with the safety feature 320 and retrieve the program headers 314 and/or the loadable segments 316. The SWIV runtime module 208 may analyze the program headers 314 and/or the loadable segments 316 and generate segment information 506 relating to the loadable segments 316. The segment information 506 may include a number of the loadable segments 316, a size of the loadable segments 316, etc, and a segment identifier and a memory location identifier, such as an address, address range, address offset, pointer, etc., for each loadable segment 316. The SWIV runtime module 208 may use the retrieved safety feature, checksum 400, and the segment information 506 to generate the SWIV context object 212.

The SWIV runtime module 208 may verify the safety of the software image with the safety feature 320 based on information of the SWIV context object 212. The SWIV runtime module 208 may use any of the segment information 506 to calculate a safety feature, checksum 508, of the software image with the safety feature 320. For example, the SWIV runtime module 208 may use the same manner of calculating the safety feature as used by the SWIV build utility module 204 to generate the safety feature, checksum 508. The SWIV runtime module 208 may compare the calculated safety feature, checksum 508, with the retrieved safety feature, checksum 400, from the SWIV context object 212 to determine whether to verify the safety of the software image with the safety feature 320. Verification of the safety of the software image with the safety feature 320 may verify that the software image with the safety feature 320 is correctly loaded to the RAM 502. For example, the software image with the safety feature 320 is correctly loaded to RAM when the expected parts of the software image with the safety feature 320, such as loadable segments 316 and/or SWIV segment 324, are loaded to the RAM 502, such as segments 504a-504c and/or SWIV segment 324, at expected destination address with intact or noncorrupted data.

The image loader 500 and the SWIV runtime module 208 may be implemented in software executing in a processor (e.g., CPU 104, processor 124 in FIG. 1), dedicated hardware, and/or in a combination of software executing in the processor and dedicated hardware.

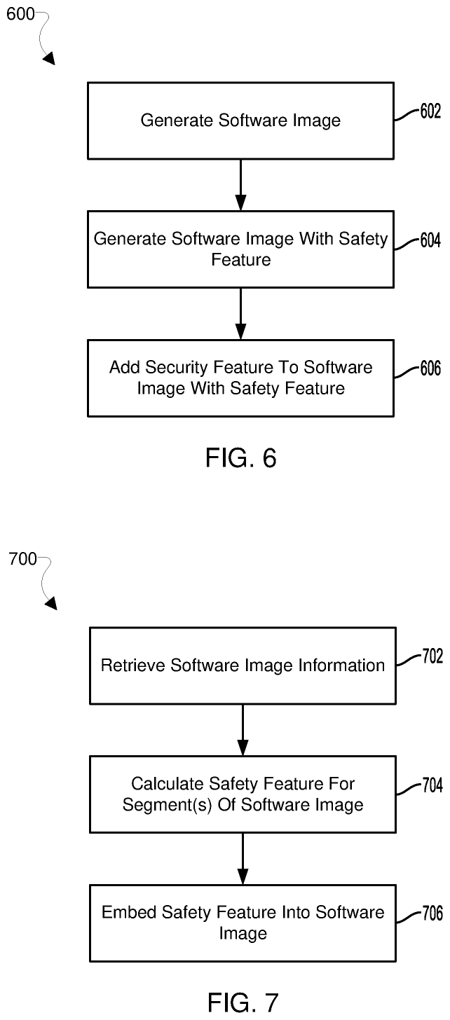

FIG. 6 illustrates a method 600 for generating a software image with a safety feature using functional safety standard compliant modules according to an embodiment. With reference to FIGS. 1-6, the method 600 may be implemented in a computing device (e.g., computing device 100), in hardware, in software executing in a processor, or in a combination of a software-configured processor and dedicated hardware (e.g., CPU 104, processor 124 in FIG. 1, functional safety standard compliant SWIV module 200, SWIV generate module 206 in FIG. 2, functional safety standard compliant SWIV build utility module 204 in FIGS. 2 and 3, compiler and linker 302 in FIG. 3) that includes other individual components, such as various memories/caches (e.g., memory 106, 114 in FIG. 1) and various memory/cache controllers. In order to encompass the alternative configurations enabled in various embodiments, the hardware implementing the method 600 is referred to herein as a “processing device.”

In block 602, the processing device may generate a software image (e.g., software image 310). The processing device may receive source code and data (e.g., source code and data 300 in FIG. 3) and generate the software image of the source code and data. The software image may be of any format software image, such as an ELF software image, MBN software image, etc. The software image may contain an image header (e.g., image header 312 in FIG. 3) containing metadata for the software image, any number of program headers (e.g., program headers 314 in FIG. 3) containing metadata for loadable segments (e.g., loadable segments 316 in FIG. 3) of the software image, and any number of segments containing the complied binary of the source code and data. The processing device generating the software image in block 602 may be, for example, a CPU, a processor, and/or a compiler and linker.

In block 604, the processing device may generate a software image with a safety feature (e.g., software image with a safety feature 320 in FIGS. 3-5). Generating the software image with the safety feature may include adding a safety feature, such as checksum, to the software image. Adding the safety feature to the software image is further described herein for the method 700 with reference to FIG. 7. The processing device generating the software image with the safety feature in block 604 may be, for example, a CPU, a processor, a compiler and linker, a functional safety standard compliant SWIV module, a functional safety standard compliant SWIV build utility module, and/or a SWIV generate module.

In block 606, the processing device may add a security feature to the software image with the safety feature. For example, adding the security feature may include embedding the security feature in the software image with the safety feature, such as in a SWIV segment (e.g., SWIV segment 324 in FIGS. 3-5). For example, the SWIV segment may contain the security feature, such as magic number for use with cryptographic functions for securing the software image with the safety feature. The security feature may be used to apply cryptographic functions for securing the software image with the safety feature and to unsecure the software image with the safety feature. For example hashing and unhashing of the software image with the safety feature. The processing device adding the security feature to the software image with the safety feature in block 606 may be, for example, a CPU, a processor, a functional safety standard compliant SWIV module, a functional safety standard compliant SWIV build utility module, and/or a SWIV generate module.

FIG. 7 illustrates a method 700 for generating a software image with a safety feature using functional safety standard compliant modules according to an embodiment. With reference to FIGS. 1-7, the method 700 may be implemented in a computing device (e.g., computing device 100), in hardware, in software executing in a processor, or in a combination of a software-configured processor and dedicated hardware (e.g., CPU 104, processor 124 in FIG. 1, functional safety standard compliant SWIV module 200, SWIV generate module 206 in FIG. 2, functional safety standard compliant SWIV build utility module 204 in FIGS. 2 and 3) that includes other individual components, such as various memories/caches (e.g., memory 106, 114 in FIG. 1) and various memory/cache controllers. In order to encompass the alternative configurations enabled in various embodiments, the hardware implementing the method 700 is referred to herein as a “processing device.” The method 700 may further describe block 604 of the method 600 described herein with reference to FIG. 6.

In block 702, the processing device may retrieve/receive software image information. The processing device may retrieve/receive software image information from a software image (e.g., software image 310 in FIG. 3) generated in block 602 of the method 600, described with reference to FIG. 6. Such software image information may include information relating to loadable segments (e.g., loadable segments 316 in FIG. 3) of the software image. For example, software image information may include a number of the loadable segments, a size of the loadable segments, etc. The processing device retrieving/receiving the software image information in block 702 may be, for example, a CPU, a processor, a functional safety standard compliant SWIV module, a functional safety standard compliant SWIV build utility module, and/or a SWIV generate module.

In block 704, the processing device may calculate a safety feature for the segments of the software image. The processing device may use the software image information to generate the safety feature for use in generating the software image with the safety feature (e.g., software image with the safety feature 320 in FIGS. 3-5). For example, the processing device may calculate an error detection code checksum based on the software image information as the safety feature. For example, the processing device may calculate a cyclic redundancy check (CRC) checksum as the safety feature. The processing device calculating the safety feature for the segments of the software image in block 704 may be, for example, a CPU, a processor, a functional safety standard compliant SWIV module, a functional safety standard compliant SWIV build utility module, and/or a SWIV generate module.

In block 706, the processing device may embed the safety feature into the software image. The processing device may generate a SWIV header (e.g., SWIV header 322 in FIGS. 3-5) and a SWIV segment (e.g., SWIV segment 324 in FIGS. 3-5) for a software image with the safety feature (e.g., software image with the safety feature 320 in FIGS. 3-5). The SWIV header may contain metadata for the SWIV segment, such as a memory location identifier, such as an address, address range, address offset, pointer, etc., for the SWIV segment when loaded to RAM (e.g., memory 106 in FIG. 1, RAM 502 in FIG. 5). The SWIV segment may include the safety feature. The SWIV segment may also include a magic number for use with cryptographic functions for securing the software image with the safety feature. The processing device may generate the software image with the safety feature. For example, the processing device may add the SWIV header and the SWIV segment to the software image, generating the software image with the safety feature. The processing device embedding the safety feature into the software image in block 706 may be, for example, a CPU, a processor, a functional safety standard compliant SWIV module, a functional safety standard compliant SWIV build utility module, and/or a SWIV generate module.

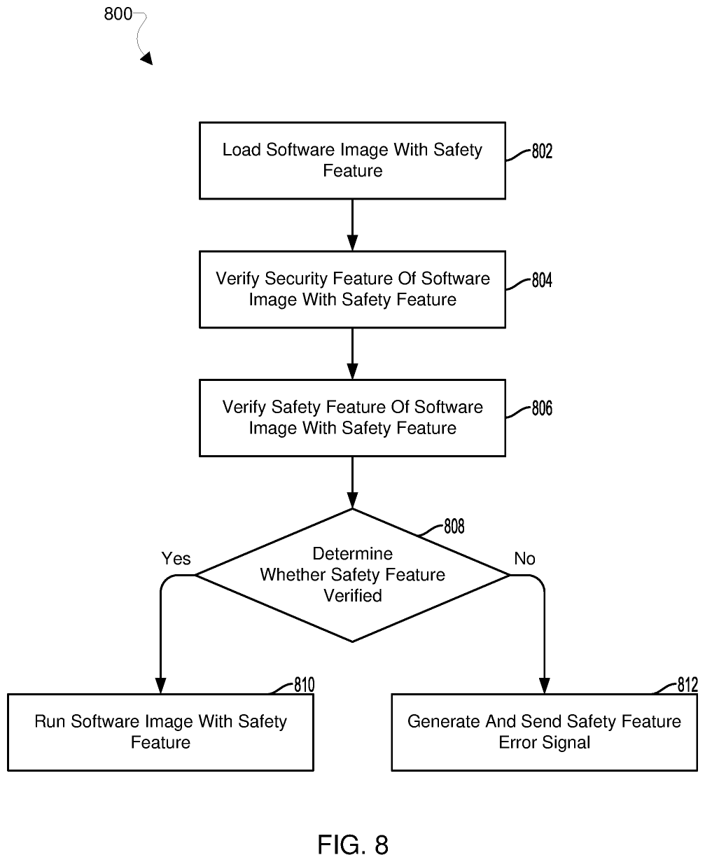

FIG. 8 illustrates a method 800 for verifying a software image with a safety feature using functional safety standard compliant modules according to an embodiment. With reference to FIGS. 1-8, the method 800 may be implemented in a computing device (e.g., computing device 100), in hardware, in software executing in a processor, or in a combination of a software-configured processor and dedicated hardware (e.g., CPU 104, processor 124 in FIG. 1, functional safety standard compliant SWIV module 200, functional safety standard compliant SWIV runtime module 208 in FIGS. 2 and 5, SWIV parse module 214, SWIV verify module 216 in FIGS. 2 and 4, image loader 500 in FIG. 5) that includes other individual components, such as various memories/caches (e.g., memory 106, 114 in FIG. 1, RAM 502 in FIG. 5) and various memory/cache controllers. In order to encompass the alternative configurations enabled in various embodiments, the hardware implementing the method 800 is referred to herein as a “processing device.”

In block 802, the processing device may load a software image with a safety feature (e.g., software image with safety feature 320 in FIGS. 3-5). The processing device may load the software image having the safety feature to a RAM of a computing device. The processing device may load segments (e.g., loadable segments 316 in FIGS. 3-5) of the software image having the safety feature as segments (e.g., segments 504a-504c in FIG. 5) to the RAM based on metadata from an image header (e.g., image header 312 in FIGS. 3-5) and/or a program headers (e.g., program headers 314 in FIGS. 3-5) of the software image having the safety feature. For example, the metadata may indicate to the processing device at which locations in the RAM to load the segments. The processing device may load a SWIV segment (e.g., SWIV segment 324 in FIGS. 3-5) of the software image having the safety feature to the RAM based on metadata from a SWIV header (e.g., SWIV header 322 in FIGS. 3-5) of the software image having the safety feature. For example, the metadata may indicate to the processing device at which location in the RAM to load the SWIV segment. The processing device loading the software image with the safety feature in block 802 may be, for example, a CPU, a processor, and/or an image loader.

In block 804, the processing device may verify a security feature of the software image with the safety feature. The processing device may apply cryptographic functions for unsecuring the software image with the safety feature. The security feature may be used to verify successful application of the cryptographic functions for unsecuring the software image with the safety feature. For example, unhashing of the software image with the safety feature. The security feature may be retrieve from the unsecured software image with the safety feature, such as from the SWIV segment. The retrieved security feature may be verified by the processing device, such as via comparison to a value and/or algorithmically. The processing device verifying the security feature of the software image with the safety feature in block 804 may be, for example, a CPU, a processor, an image loader, functional safety standard compliant SWIV module, and/or a functional safety standard compliant SWIV runtime module.

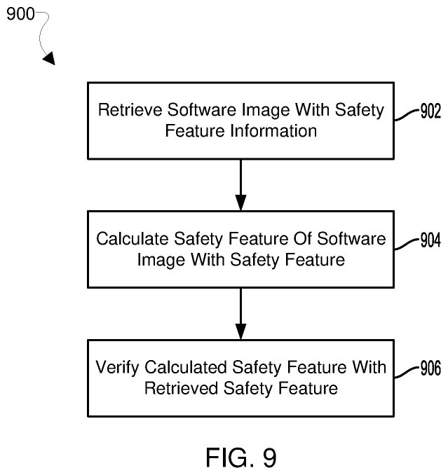

In block 806, the processing device may verify the safety feature of the software image with the safety feature. Verifying the safety feature of the software image with the safety feature may be used as verification of a safety of the software image with the safety feature for execution in a critical system. Verifying the safety feature of the software image may include retrieving the safety feature (e.g., checksum 400 in FIGS. 4 and 5) from the software image with the safety feature, calculating a safety feature (e.g., checksum 508 in FIG. 5) for the software image with the safety feature, and comparing the retrieved safety feature and the calculated safety feature to determine whether to verify the safety feature. Verification of the safety of the software image with the safety feature may verify that the software image with the safety feature is correctly loaded to the RAM. For example, the software image with the safety feature is correctly loaded to RAM when the expected parts of the software image with the safety feature, such as the segments and/or the SWIV segment, are loaded to the RAM at expected destination address with noncorrupted or intact data. Verifying the safety feature of the software image with the safety feature is further described herein for the method 900 with reference to FIG. 9. The processing device verifying the safety feature of the software image with the safety feature in block 806 may be, for example, a CPU, a processor, a functional safety standard compliant SWIV module, a functional safety standard compliant SWIV runtime module, a SWIV parse module, and/or a SWIV verify module.

In determination block 808, the processing device may determine whether the safety feature of the software image with the safety feature is verified. Verifying the safety feature of the software image with the safety feature in block 806, by comparing the retrieved safety feature and the calculated safety feature, may result in a match or a mismatch between the retrieved safety feature and the calculated safety feature. In response to the retrieved safety feature matching the calculated safety feature, the processing device may determine that the safety feature of the software image with the safety feature is verified. In response to a mismatch between the retrieved safety feature and the calculated safety feature, the processing device may determine that the safety feature of the software image with the safety feature is not verified. The processing device determining whether the safety feature of the software image with the safety feature is verified in determination block 808 may be, for example, a CPU, a processor, a functional safety standard compliant SWIV module, a functional safety standard compliant SWIV runtime module, and/or a SWIV verify module.

In response to determining that the safety feature of the software image with the safety feature is verified (i.e., determination block 808=“Yes”), the processing device may run the software image with the safety feature in block 810. The processing device may execute the verified safe software image with the safety feature for a critical system of a computing device. The processing device running the software image with the safety feature in block 810 may be, for example, a CPU and/or a processor.

In response to determining that the safety feature of the software image with the safety feature is not verified (i.e., determination block 808=“No”), the processing device may generate and send a safety feature error signal in block 812. The safety feature error signal may be configured to indicate to a processor that a safety of the software image with the safety feature is not verified for execution in the critical system of the computing device. The processing device generating and sending the safety feature error signal in block 812 may be, for example, a CPU, a processor, a functional safety standard compliant SWIV module, a functional safety standard compliant SWIV runtime module, and/or a SWIV verify module.

FIG. 9 illustrates a method 900 for verifying a software image with a safety feature using functional safety standard compliant modules according to an embodiment. With reference to FIGS. 1-9, the method 900 may be implemented in a computing device (e.g., computing device 100), in hardware, in software executing in a processor, or in a combination of a software-configured processor and dedicated hardware (e.g., CPU 104, processor 124 in FIG. 1, functional safety standard compliant SWIV module 200, functional safety standard compliant SWIV runtime module 208 in FIGS. 2 and 5, SWIV parse module 214, SWIV verify module 216 in FIGS. 2 and 4) that includes other individual components, such as various memories/caches (e.g., memory 106, 114 in FIG. 1, RAM 502 in FIG. 5) and various memory/cache controllers. In order to encompass the alternative configurations enabled in various embodiments, the hardware implementing the method 900 is referred to herein as a “processing device.” The method 900 may further describe block 806 of the method 800 described herein with reference to FIG. 8.

In block 902, the processing device may retrieve software image with safety feature information. The processing device retrieving the software image with safety feature information in block 902 may be, for example, a CPU, a processor, a functional safety standard compliant SWIV module, a functional safety standard compliant SWIV runtime module, and/or a SWIV parse module. The information may include a safety feature in a SWIV segment (e.g., SWIV segment 324 in FIGS. 3-5) of a software image with the safety feature (e.g., software image with the safety feature 320 in FIGS. 3-5). For example, the processing device may retrieve a checksum from the SWIV segment of the software image with the safety feature. The processing device may use the information retrieved from the software image with the safety feature to generate a context of the software image with the safety feature (or SWIV context; e.g., SWIV context object 212 in FIGS. 2, 4, and 5). For example, the SWIV context may be generated having the safety feature (e.g., checksum 400 in FIG. 4) retrieved from the software image with the safety feature.

The processing device may also analyze information retrieved from the software image with the safety feature and generate segment information (e.g., segment information 506 in FIG. 5) relating to the segments (e.g., loadable segments 316 in FIGS. 3-5) of the software image with the safety feature. The segment information may include the data of the program headers (e.g., program headers 314 in FIGS. 3-5) and/or the loadable segments. For example, the processing device may generate segment information that includes a number of the loadable segments, a size of the loadable segments, etc. As another example, the processing device may generate segment information that may include a segment identifier and a memory location identifier, such as an address, address range, address offset, pointer, etc., for each loadable segment of the software image with the safety feature. The processing device may use the segment information generated from analyzing the software image with the safety feature to generate the SWIV context. For example, the SWIV context may be generated having a number of the loadable segments (e.g., loadable segments 402 in FIG. 4). As another example, the SWIV context may be generated having segment identifiers and the memory location identifiers for the loadable segments (e.g., segment list 210 in FIGS. 2 and 4).

In block 904, the processing device may calculate a safety feature (e.g., checksum 508 in FIG. 5) of the software image with the safety feature. The processing device may calculate the safety feature of the software image with the safety feature based on information of the SWIV context. The SWIV runtime module 208 may use the generated information relating to the loadable segments to calculate a safety feature of the software image with the safety feature. For example, the processing device may use the same manner of calculating the safety feature as used to generate the safety feature as described for block 704 of the method 700 with reference to FIG. 7. For example, the processing device may calculate an error detection code checksum based on the information relating to the loadable segments as the safety feature. For example, the processing device may calculate a cyclic redundancy check (CRC) checksum as the safety feature. The processing device calculating the safety feature of the software image having the safety feature in block 904 may be, for example, a CPU, a processor, a functional safety standard compliant SWIV module, a functional safety standard compliant SWIV runtime module, and/or a SWIV verify module.

In block 906, the processing device may verify the calculated safety feature with the retrieved safety feature. The processing device may compare the calculated safety feature with the retrieved safety feature, such as from the SWIV context, to determine whether to verify the safety of the software image with the safety feature. In response to the calculated safety feature and the retrieved safety feature matching, the processing device may verify the safety of the software image with the safety feature. In response to the calculated safety feature and the retrieved safety feature not matching, the processing device may not verify the safety of the software image with the safety feature. The processing device verifying the calculated safety feature with the retrieved safety feature in block 906 may be, for example, a CPU, a processor, a functional safety standard compliant SWIV module, a functional safety standard compliant SWIV runtime module, and/or a SWIV verify module.

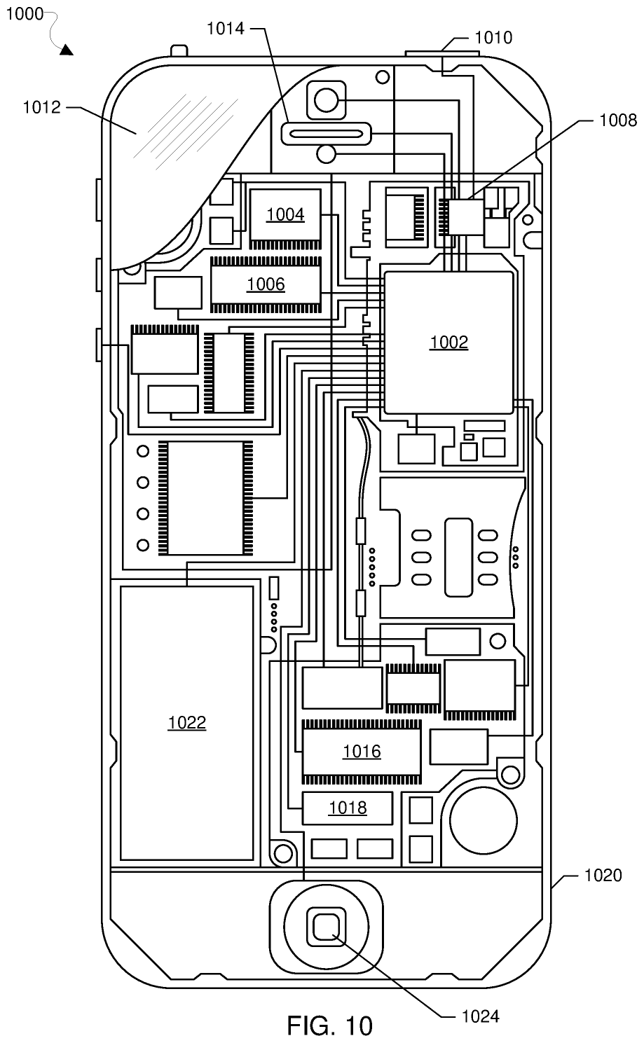

A system in accordance with the various embodiments (including, but not limited to, embodiments described above with reference to FIGS. 1-9) may be implemented in a wide variety of computing systems including mobile computing devices, an example of which suitable for use with the various embodiments is illustrated in FIG. 10. The mobile computing device 1000 may include a processor 1002 coupled to a touchscreen controller 1004 and an internal memory 1006. The processor 1002 may be one or more multicore integrated circuits designated for general or specific processing tasks. The internal memory 1006 may be volatile or non-volatile memory, and may also be secure and/or encrypted memory, or unsecure and/or unencrypted memory, or any combination thereof. Examples of memory types that can be leveraged include but are not limited to DDR, LPDDR, GDDR, WIDEIO, RAM, SRAM, DRAM, P-RAM, R-RAM, M-RAM, STT-RAM, and embedded DRAM. The touchscreen controller 1004 and the processor 1002 may also be coupled to a touchscreen panel 1012, such as a resistive-sensing touchscreen, capacitive-sensing touchscreen, infrared sensing touchscreen, etc. Additionally, the display of the mobile computing device 1000 need not have touch screen capability.

The mobile computing device 1000 may have one or more radio signal transceivers 1008 (e.g., Peanut, Bluetooth, ZigBee, Wi-Fi, RF radio) and antennae 1010, for sending and receiving communications, coupled to each other and/or to the processor 1002. The transceivers 1008 and antennae 1010 may be used with the above-mentioned circuitry to implement the various wireless transmission protocol stacks and interfaces. The mobile computing device 1000 may include a cellular network wireless modem chip 1016 that enables communication via a cellular network and is coupled to the processor.

The mobile computing device 1000 may include a peripheral device connection interface 1018 coupled to the processor 1002. The peripheral device connection interface 1018 may be singularly configured to accept one type of connection, or may be configured to accept various types of physical and communication connections, common or proprietary, such as Universal Serial Bus (USB), FireWire, Thunderbolt, or PCIe. The peripheral device connection interface 1018 may also be coupled to a similarly configured peripheral device connection port (not shown).

The mobile computing device 1000 may also include speakers 1014 for providing audio outputs. The mobile computing device 1000 may also include a housing 1020, constructed of a plastic, metal, or a combination of materials, for containing all or some of the components described herein. The mobile computing device 1000 may include a power source 1022 coupled to the processor 1002, such as a disposable or rechargeable battery. The rechargeable battery may also be coupled to the peripheral device connection port to receive a charging current from a source external to the mobile computing device 1000. The mobile computing device 1000 may also include a physical button 1024 for receiving user inputs. The mobile computing device 1000 may also include a power button 1024 for turning the mobile computing device 1000 on and off.

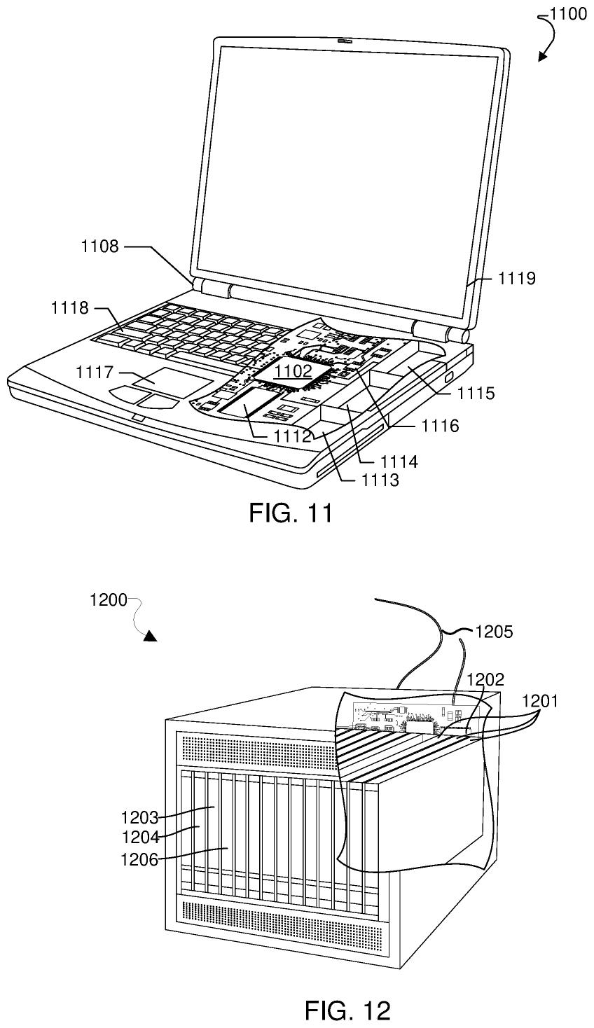

A system in accordance with the various embodiments (including, but not limited to, embodiments described above with reference to FIGS. 1-9) may be implemented in a wide variety of computing systems include a laptop computer 1100 an example of which is illustrated in FIG. 11. Many laptop computers include a touchpad touch surface 1117 that serves as the computer's pointing device, and thus may receive drag, scroll, and flick gestures similar to those implemented on computing devices equipped with a touch screen display and described above. A laptop computer 1100 will typically include a processor 1102 coupled to volatile memory 1112 and a large capacity nonvolatile memory, such as a disk drive 1113 of Flash memory. Additionally, the computer 1100 may have one or more antenna 1108 for sending and receiving electromagnetic radiation that may be connected to a wireless data link and/or cellular telephone transceiver 1116 coupled to the processor 1102. The computer 1100 may also include a floppy disc drive 1114 and a compact disc (CD) drive 1115 coupled to the processor 1102. In a notebook configuration, the computer housing includes the touchpad 1117, the keyboard 1118, and the display 1119 all coupled to the processor 1102. Other configurations of the computing device may include a computer mouse or trackball coupled to the processor (e.g., via a USB input) as are well known, which may also be used in conjunction with the various embodiments.

A system in accordance with the various embodiments (including, but not limited to, embodiments described above with reference to FIGS. 1-9) may also be implemented in fixed computing systems, such as any of a variety of commercially available servers. An example server 1200 is illustrated in FIG. 12. Such a server 1200 typically includes one or more multicore processor assemblies 1201 coupled to volatile memory 1202 and a large capacity nonvolatile memory, such as a disk drive 1204. As illustrated in FIG. 12, multicore processor assemblies 1201 may be added to the server 1200 by inserting them into the racks of the assembly. The server 1200 may also include a floppy disc drive, compact disc (CD) or digital versatile disc (DVD) disc drive 1206 coupled to the processor 1201. The server 1200 may also include network access ports 1203 coupled to the multicore processor assemblies 1201 for establishing network interface connections with a network 1205, such as a local area network coupled to other broadcast system computers and servers, the Internet, the public switched telephone network, and/or a cellular data network (e.g., CDMA, TDMA, GSM, PCS, 3G, 4G, LTE, 5G or any other type of cellular data network).

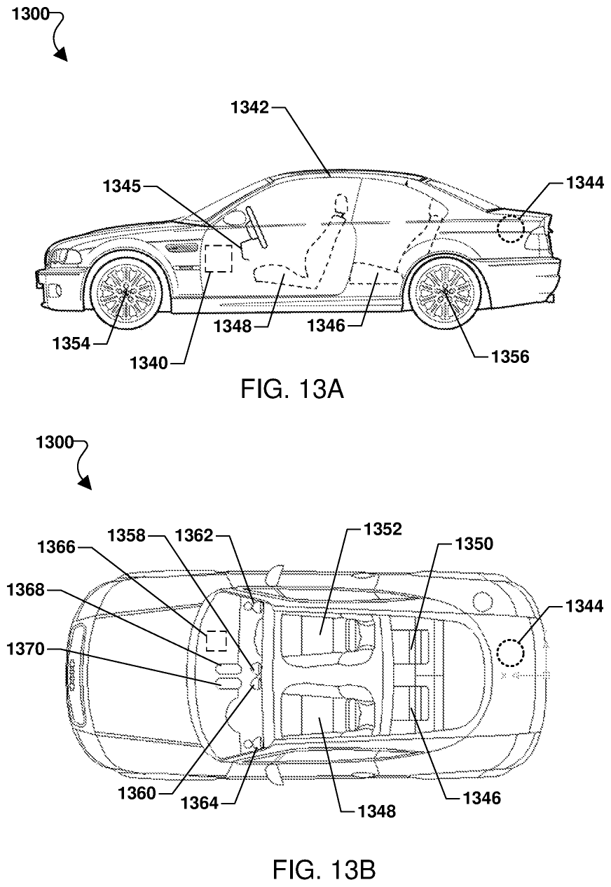

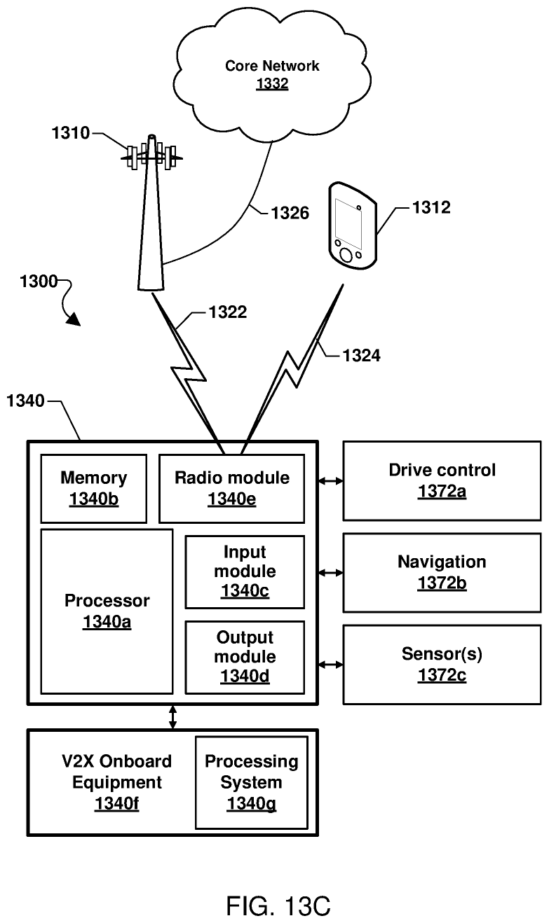

Methods and devices for implementing such methods in accordance with the various embodiments (including, but not limited to, embodiments described above with reference to FIGS. 1-9) may be implemented in a wide variety of computing systems including an embedded vehicle computing system 1300 an example of which is illustrated in FIGS. 13A-13C. An embedded vehicle computing system 1300 may include a vehicle control unit 1340, such as an ECU, which may include a processor, such as a CPU, an AI processor, etc. The embedded vehicle computing system 1300 may include a plurality of sensors 1342-1370, including satellite geopositioning system receivers 1342, accelerometers 1344, occupancy sensors 1346, 1348, 1350, 1352, tire pressure sensors 1354, 1356, cameras 1358, 1360, microphones 1362, 1364, impact sensors 1366, radar 1368, and LiDAR 1370.

The plurality of sensors 1342-1370, disposed in or on the vehicle, may be used for various purposes, such as autonomous and semi-autonomous navigation and control, crash avoidance, position determination, etc., as well to provide sensor data regarding objects and people in or on the vehicle. The sensors 1342-1370 may include one or more of a wide variety of sensors capable of detecting a variety of information useful for navigation and collision avoidance. Each of the sensors 1342-1370 may be in wired or wireless communication with a control unit 1340, as well as with each other. In particular, the sensors may include one or more cameras 1358, 1360 or other optical sensors or photo optic sensors. The sensors may further include other types of object detection and ranging sensors, such as radar 1368, LiDAR 1370, IR sensors, and ultrasonic sensors. The sensors may further include tire pressure sensors 1354, 1356, humidity sensors, temperature sensors, satellite geopositioning sensors 1342, control input sensors 1345, accelerometers 1344, vibration sensors, gyroscopes, gravimeters, impact sensors 1366, force meters, stress meters, strain sensors, fluid sensors, chemical sensors, gas content analyzers, pH sensors, radiation sensors, Geiger counters, neutron detectors, biological material sensors, microphones 1362, 1364, occupancy sensors 1346, 1348, 1350, 1352, proximity sensors, and other sensors.

The vehicle control unit 1340 may include one or more processors configured with processor-executable instructions to perform navigation and collision avoidance operations using information received from various sensors, particularly the cameras 1358, 1360. In some embodiments, the control unit 1340 may supplement the processing of camera images using distance and relative position (e.g., relative bearing angle) that may be obtained from radar 1368 and/or LiDAR 1370 sensors. The control unit 1340 may further be configured to control steering, breaking and speed of the vehicle when operating in an autonomous or semi-autonomous mode using information regarding other vehicles determined using various embodiments. The vehicle control unit 1340 may include one or more processors configured with processor-executable instructions to receive information from the sensors 1342-1370 and to perform operations using such information as further described herein. In various embodiments, the vehicle control unit 1340 may include, be a component of, or communicate with V2X onboard equipment of the vehicle.

FIG. 13C is a component block diagram illustrating the embedded vehicle computing system 1300 including components and support systems suitable for implementing various embodiments. The embedded vehicle computing system 1300 may include the control unit 1340, which may include various circuits and devices used to control the operation of the vehicle. The control unit 1340 may include a processor 1340a, such as a CPU, an AI processor, etc., a memory 1340b, an input module 1340c, an output module 1340d, and a radio module 1340e. The control unit 1340 may be coupled to and configured to control drive control components 1372a, navigation components 1372b, and one or more sensors 1372c of the embedded vehicle computing system 1300. The control unit 1340 may communicate with V2X onboard equipment 1340f. The processor 1340a may be configured with processor-executable instructions to control maneuvering, navigation, and/or other operations of the vehicle, including operations of various embodiments, including gathering and analyzing real-world autonomous vehicle run data gathered from the sensors 1372c. The processor 1340a may be coupled to the memory 1340b. The V2X onboard equipment 1340f may include one or more processors 1340g configured with processor-executable instructions to perform various operations of various embodiments, including communicating real-world autonomous vehicle run data gathered from the sensors 1372c between the embedded vehicle computing system 1200 and a wireless communication device 1312 and/or the computing device on a communication network (e.g., a core network 1332) via the radio module 1340e.

The radio module 1340e may be configured for wireless communication. The radio module 1340e may exchange signals (e.g., command signals for controlling maneuvering, signals from navigation facilities, data signals, etc.) via a communication link 1322 with a network transceiver (e.g., the base station 1310), and may provide the signals to the processor 1340a, 1340g and/or the navigation unit 1372b. In some embodiments, the radio module 1340e may enable the embedded vehicle computing system 1300 to communicate with a wireless communication device 1312 through the wireless communication link 1324. The wireless communication link 1324 may be a bidirectional or unidirectional communication link, and may use one or more communication protocols.

The input module 1340c may receive sensor data from one or more vehicle sensors 1372c as well as electronic signals from other components, including the drive control components 1372a and the navigation components 1372b. The output module 1340d may communicate with or activate various components of the embedded vehicle computing system 1300, including the drive control components 1372a, the navigation components 1372b, and the sensor(s) 1372c.

The control unit 1340 may be coupled to the drive control components 1372a to control physical elements of the vehicle related to maneuvering and navigation of the vehicle, such as the engine, motors, throttles, steering elements, flight control elements, braking or deceleration elements, and the like. The drive control components 1372a may also include components that control other devices of the vehicle, including interior environment controls (e.g., air conditioning and heating), external and/or interior lighting, interior and/or exterior informational displays (which may include a display screen or other devices to display information), safety devices (e.g., haptic devices, audible alarms, etc.), and other similar devices.

The control unit 1340 may be coupled to the navigation components 1372b, and may receive data from the navigation components 1372b and be configured to use such data to determine the present position and orientation of the vehicle, as well as an appropriate course toward a destination. The navigation components 1372b may include or be coupled to a global navigation satellite system (GNSS) receiver system (e.g., one or more Global Positioning System (GPS) receivers) enabling the embedded vehicle computing system 1300 to determine its current position using GNSS signals. Alternatively, or in addition, the navigation components 1372b may include radio navigation receivers for receiving navigation beacons or other signals from radio nodes, such as Wi-Fi access points, cellular network sites, radio station, remote computing devices, other vehicles, etc. Through control of the drive control elements 1372a, the processor 1340a may control the vehicle to navigate and maneuver. The processor 1340a, 1340g and/or the navigation components 1372b may be configured to communicate with a network element such as a server in a communication network (e.g., a core network 1332) via the wireless communication link 1322, 1326 to receive commands to control maneuvering, receive data useful in navigation, provide real-time position reports, etc.

The control unit 1340 may be coupled to one or more sensors 1372c. The sensor(s) 1372c may include the sensors 1342-1370 as described, and may the configured to provide a variety of data to the processor 1340a, 1340g.

While the control unit 1340 is described as including separate components, in some embodiments some or all of the components (e.g., the processor 1340a, the memory 1340b, the input module 1340c, the output module 1340d, and the radio module 1340e) may be integrated in a single device or module, such as an SoC processing device. Such an SoC processing device may be configured for use in vehicles and be configured, such as with processor-executable instructions executing in the processor 1340a, to perform operations of navigation and collision avoidance.

Implementation examples are described in the following paragraphs. While some of the following implementation examples are described in terms of example methods, further example implementations may include: the example methods discussed in the following paragraphs implemented by a computing device comprising a processing device configured with processing device-executable instructions to perform operations of the example methods; the example methods discussed in the following paragraphs implemented by a computing device including means for performing functions of the example methods; and the example methods discussed in the following paragraphs implemented as a non-transitory processor-readable storage medium having stored thereon processor-executable instructions configured to cause a processor of a computing device to perform the operations of the example methods.

Example 1. A method of generating a software image, including generating a safety feature from a first software image, and generating a second software image including the safety feature.

Example 2. The method of example 1, in which generating the second software image including the safety feature includes embedding the safety feature in the first software image.

Example 3. The method of any of examples 1 or 2, in which generating the safety feature from the first software image includes retrieving information relating to segments of the first software image, calculating an error detection code based on the information relating to the segments of the first software image producing a checksum value, and generating the second software image including the safety feature may include generating the second software image including the checksum value.

Example 4. The method of any of examples 1-3, in which generating the second software image including the safety feature includes generating a software image verifier (SWIV) header, generating a SWIV segment including the safety feature, and generating the second software image including the SWIV header and the SWIV segment.

Example 5. The method of any of examples 1-4, in which generating the safety feature from the first software image includes generating the safety feature via a functional safety standard compliant module, and generating the second software image including the safety feature includes generating the second software image including the safety feature via the functional safety standard compliant module.

Example 6. The method of any of examples 1-5, in which the functional safety standard compliant module is an ISO 26262 functional safety standard compliant module.

Example 7. The method of any of examples 1-6, in which the functional safety standard compliant module is an Automotive Safety Integrity Level (ASIL)-QM functional safety standard compliant module.

Example 8. A method of verifying a software image, including retrieving a first safety feature from a software image with the first safety feature, calculating a second safety feature based on information relating to the software image with the first safety feature, comparing the first safety feature and the second safety feature, and verifying safety of the software image with the first safety feature in response to the first safety feature matching the second safety feature.

Example 9. The method of example 9, in which retrieving the first safety feature from the software image with the first safety feature includes retrieving the first safety feature from a software image verifier (SWIV) segment of the software image with the first safety feature.

Example 10. The method of any of examples 8 or 9, further including retrieving the information relating to the software image with the first safety feature from the software image with the first safety feature, generating a software image verifier (SWIV) context including the first safety feature and the information relating to the software image with the first safety feature, retrieving the information relating to the software image with the first safety feature from the SWIV context, in which calculating the second safety feature based on the information relating to the software image with the first safety feature includes calculating the second safety feature based on the information relating to the software image retrieved from the SWIV context, and retrieving the first safety feature from the SWIV context, in which comparing the first safety feature and the second safety feature includes comparing the first safety feature retrieved from the SWIV context and the second safety feature.

Example 11. The method of any of examples 8-10, further including loading the software image with the first safety feature to a volatile memory, in which retrieving the first safety feature from the software image with the first safety feature, calculating the second safety feature based on the information relating to the software image with the first safety feature, comparing the first safety feature and the second safety feature, and verifying the safety of the software image with the first safety feature in response to the first safety feature matching with the second safety feature occur following loading the software image with the first safety feature to the volatile memory.

Example 12. The method of any of examples 8-11, in which retrieving the first safety feature from the software image with the first safety feature, calculating the second safety feature based on the information relating to the software image with the first safety feature, comparing the first safety feature and the second safety feature, and verifying the safety of the software image with the first safety feature in response to the first safety feature matching with the second safety feature occur prior to each execution of the software image with the first safety feature.

Example 13. The method of any of examples 8-12, in which retrieving the first safety feature from the software image with the first safety feature includes retrieving the first safety feature from the software image with the first safety feature via a functional safety standard compliant module, calculating the second safety feature based on information relating to the software image with the first safety feature includes calculating the second safety feature based on the information relating to the software image with the first safety feature via the functional safety standard compliant module, comparing the first safety feature and the second safety feature includes comparing the first safety feature and the second safety feature via the functional safety standard compliant module, and verifying safety of the software image with the first safety feature in response to the first safety feature matching with the second safety feature includes verifying the safety of the software image with the first safety feature via the functional safety standard compliant module.

Example 14. The method of any of examples 8-13, in which the functional safety standard compliant module is an ISO 26262 functional safety standard compliant module.

Example 15. The method of any of examples 8-14, in which the functional safety standard compliant module is an Automotive Safety Integrity Level (ASIL)-D functional safety standard compliant module.

Computer program code or “program code” for execution on a programmable processor for carrying out operations of the various embodiments may be written in a high level programming language such as C, C++, C#, Smalltalk, Java, JavaScript, Visual Basic, a Structured Query Language (e.g., Transact-SQL), Perl, or in various other programming languages. Program code or programs stored on a computer readable storage medium as used in this application may refer to machine language code (such as object code) whose format is understandable by a processor.

The foregoing method descriptions and the process flow diagrams are provided merely as illustrative examples and are not intended to require or imply that the operations of the various embodiments must be performed in the order presented. As will be appreciated by one of skill in the art the order of operations in the foregoing embodiments may be performed in any order. Words such as “thereafter,” “then,” “next,” etc. are not intended to limit the order of the operations; these words are simply used to guide the reader through the description of the methods. Further, any reference to claim elements in the singular, for example, using the articles “a,” “an” or “the” is not to be construed as limiting the element to the singular.

The various illustrative logical blocks, modules, circuits, and algorithm operations described in connection with the various embodiments may be implemented as electronic hardware, computer software, or combinations of both. To clearly illustrate this interchangeability of hardware and software, various illustrative components, blocks, modules, circuits, and operations have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the claims.

The hardware used to implement the various illustrative logics, logical blocks, modules, and circuits described in connection with the embodiments disclosed herein may be implemented or performed with a general purpose processor, a digital signal processor (DSP), an application-specific integrated circuit (ASIC), a field programmable gate array (FPGA) or other programmable logic device, discrete gate or transistor logic, discrete hardware components, or any combination thereof designed to perform the functions described herein. A general-purpose processor may be a microprocessor, but, in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration. Alternatively, some operations or methods may be performed by circuitry that is specific to a given function.

In one or more embodiments, the functions described may be implemented in hardware, software, firmware, or any combination thereof. If implemented in software, the functions may be stored as one or more instructions or code on a non-transitory computer-readable medium or a non-transitory processor-readable medium. The operations of a method or algorithm disclosed herein may be embodied in a processor-executable software module that may reside on a non-transitory computer-readable or processor-readable storage medium. Non-transitory computer-readable or processor-readable storage media may be any storage media that may be accessed by a computer or a processor. By way of example but not limitation, such non-transitory computer-readable or processor-readable media may include RAM, ROM, EEPROM, FLASH memory, CD-ROM or other optical disk storage, magnetic disk storage or other magnetic storage devices, or any other medium that may be used to store desired program code in the form of instructions or data structures and that may be accessed by a computer. Disk and disc, as used herein, includes compact disc (CD), laser disc, optical disc, digital versatile disc (DVD), floppy disk, and Blu-ray disc where disks usually reproduce data magnetically, while discs reproduce data optically with lasers. Combinations of the above are also included within the scope of non-transitory computer-readable and processor-readable media. Additionally, the operations of a method or algorithm may reside as one or any combination or set of codes and/or instructions on a non-transitory processor-readable medium and/or computer-readable medium, which may be incorporated into a computer program product.

The preceding description of the disclosed embodiments is provided to enable any person skilled in the art to make or use the claims. Various modifications to these embodiments will be readily apparent to those skilled in the art, and the generic principles defined herein may be applied to other embodiments and implementations without departing from the scope of the claims. Thus, the present disclosure is not intended to be limited to the embodiments and implementations described herein, but is to be accorded the widest scope consistent with the following claims and the principles and novel features disclosed herein.

What is claimed is:

1. A method of generating a software image, comprising:
generating a safety feature from a first software image; and
generating a second software image including the safety feature.

2. The method of claim 1, wherein generating the second software image including the safety feature comprises embedding the safety feature in the first software image.

3. The method of claim 1, wherein:
generating the safety feature from the first software image comprises:
retrieving information relating to segments of the first software image;
calculating an error detection code based on the information relating to
the segments of the first software image producing a checksum value; and
generating the second software image including the safety feature comprises generating the second software image including the checksum value.

4. The method of claim 1, wherein generating the second software image including the safety feature comprises:
generating a software image verifier (SWIV) header;
generating a SWIV segment including the safety feature; and
generating the second software image including the SWIV header and the SWIV segment.

5. The method of claim 1, wherein:
generating the safety feature from the first software image comprises generating the safety feature via a functional safety standard compliant module; and
generating the second software image including the safety feature comprises generating the second software image including the safety feature via the functional safety standard compliant module.

6. The method of claim 5, wherein the functional safety standard compliant module is an ISO 26262 functional safety standard compliant module.

7. The method of claim 5, wherein the functional safety standard compliant module is an Automotive Safety Integrity Level (ASIL)-QM functional safety standard compliant module.

8. A computing device, comprising:
a processing device configured with processing device-executable instructions to:
generate a safety feature from a first software image; and
generate a second software image including the safety feature.

9. The computing device of claim 8, wherein the processing device is further configured with processing device-executable instructions to embed the safety feature in the first software image.

10. The computing device of claim 8, wherein the processing device is further configured with processing device-executable instructions to generate the safety feature from the first software image by:
retrieving information relating to segments of the first software image;
calculating an error detection code based on the information relating to the segments of the first software image producing a checksum value; and
generating the second software image including the safety feature comprises generating the second software image including the checksum value.

11. The computing device of claim 8, wherein the processing device is further configured with processing device-executable instructions to generate the second software image including the safety feature by:
generating a software image verifier (SWIV) header;
generating a SWIV segment including the safety feature; and
generating the second software image including the SWIV header and the SWIV segment.

12. The computing device of claim 8, wherein the processing device is further configured with processing device-executable instructions to:
generate the safety feature from the first software image via a functional safety standard compliant module; and
generate the second software image including the safety feature via the functional safety standard compliant module.

13. The computing device of claim 12, wherein the functional safety standard compliant module is an ISO 26262 functional safety standard compliant module.

14. The computing device of claim 12, wherein the functional safety standard compliant module is an Automotive Safety Integrity Level (ASIL)-QM functional safety standard compliant module.

15. A method of verifying a software image, comprising:
retrieving a first safety feature from a software image with the first safety feature;
calculating a second safety feature based on information relating to the software image with the first safety feature;
comparing the first safety feature and the second safety feature; and
verifying safety of the software image with the first safety feature in response to the first safety feature matching the second safety feature.

16. The method of claim 15, wherein retrieving the first safety feature from the software image with the first safety feature comprises retrieving the first safety feature from a software image verifier (SWIV) segment of the software image with the first safety feature.

17. The method of claim 15, further comprising:
retrieving the information relating to the software image with the first safety feature from the software image with the first safety feature;
generating a software image verifier (SWIV) context including the first safety feature and the information relating to the software image with the first safety feature;
retrieving the information relating to the software image with the first safety feature from the SWIV context, wherein calculating the second safety feature based on the information relating to the software image with the first safety feature comprises calculating the second safety feature based on the information relating to the software image retrieved from the SWIV context; and
retrieving the first safety feature from the SWIV context, wherein comparing the first safety feature and the second safety feature comprises comparing the first safety feature retrieved from the SWIV context and the second safety feature.

18. The method of claim 15, further comprising:
loading the software image with the first safety feature to a volatile memory, wherein retrieving the first safety feature from the software image with the first safety feature, calculating the second safety feature based on the information relating to the software image with the first safety feature, comparing the first safety feature and the second safety feature, and verifying the safety of the software image with the first safety feature in response to the first safety feature matching with the second safety feature occur following loading the software image with the first safety feature to the volatile memory.

19. The method of claim 15, wherein retrieving the first safety feature from the software image with the first safety feature, calculating the second safety feature based on the information relating to the software image with the first safety feature, comparing the first safety feature and the second safety feature, and verifying the safety of the software image with the first safety feature in response to the first safety feature matching with the second safety feature occur prior to each execution of the software image with the first safety feature.

20. The method of claim 15, wherein:
retrieving the first safety feature from the software image with the first safety feature comprises retrieving the first safety feature from the software image with the first safety feature via a functional safety standard compliant module;
calculating the second safety feature based on information relating to the software image with the first safety feature comprises calculating the second safety feature based on the information relating to the software image with the first safety feature via the functional safety standard compliant module;
comparing the first safety feature and the second safety feature comprises comparing the first safety feature and the second safety feature via the functional safety standard compliant module; and
verifying safety of the software image with the first safety feature in response to the first safety feature matching with the second safety feature comprises verifying the safety of the software image with the first safety feature via the functional safety standard compliant module.

21. The method of claim 20, wherein the functional safety standard compliant module is an ISO 26262 functional safety standard compliant module.

22. The method of claim 20, wherein the functional safety standard compliant module is an Automotive Safety Integrity Level (ASIL)-D functional safety standard in compliant module.

23. A computing device, comprising:
a processing device configured with processing device-executable instructions to:
retrieve a first safety feature from a software image with the first safety feature;
calculate a second safety feature based on information relating to the software image with the first safety feature;
compare the first safety feature and the second safety feature; and
verify safety of the software image with the first safety feature in response to the first safety feature matching the second safety feature.

24. The computing device of claim 23, wherein the processing device is further configured with processing device-executable instructions to retrieve the first safety feature from a software image verifier (SWIV) segment of the software image with the first safety feature.

25. The computing device of claim 23, wherein the processing device is further configured with processing device-executable instructions to:
retrieve the information relating to the software image with the first safety feature from the software image with the first safety feature;
generate a software image verifier (SWIV) context including the first safety feature and the information relating to the software image with the first safety feature;
retrieve the information relating to the software image with the first safety feature from the SWIV context, wherein calculating the second safety feature based on the information relating to the software image with the first safety feature comprises calculating the second safety feature based on the information relating to the software image retrieved from the SWIV context; and
retrieve the first safety feature from the SWIV context, wherein comparing the first safety feature and the second safety feature comprises comparing the first safety feature retrieved from the SWIV context and the second safety feature.

26. The computing device of claim 23, wherein the processing device is further configured with processing device-executable instructions to:
load the software image with the first safety feature to a volatile memory; and
retrieve the first safety feature from the software image with the first safety feature, calculate the second safety feature based on the information relating to the software image with the first safety feature, compare the first safety feature and the second safety feature, and verify the safety of the software image with the first safety feature in response to the first safety feature matching with the second safety feature following loading the software image with the first safety feature to the volatile memory.

27. The computing device of claim 23, wherein the processing device is further configured with processing device-executable instructions to retrieve the first safety feature from the software image with the first safety feature, calculate the second safety feature based on the information relating to the software image with the first safety feature, compare the first safety feature and the second safety feature, and verify the safety of the software image with the first safety feature in response to the first safety feature matching with the second safety feature prior to each execution of the software image with the first safety feature.

28. The computing device of claim 23, wherein the processing device is further configured with processing device-executable instructions to:
retrieve the first safety feature from the software image with the first safety feature via a functional safety standard compliant module;
calculate the second safety feature based on information relating to the software image with the first safety feature via the functional safety standard compliant module;
compare the first safety feature and the second safety feature via the functional safety standard compliant module; and
verify the safety of the software image with the first safety feature via the functional safety standard compliant module.

29. The computing device of claim 28, wherein the functional safety standard compliant module is an ISO 26262 functional safety standard compliant module.

30. The computing device of claim 28, wherein the functional safety standard compliant module is an Automotive Safety Integrity Level (ASIL)-D functional safety standard compliant module.
